(19) United States
(12) Patent Application Publication
(10) Pub. No.: US 2016/0028514 A1
(43) Pub. Date: Jan. 28, 2016

(54) Configurable Transmitter Hardware Block and Methods

(71) Applicant: LSI Corporation, San Jose, CA (US)

(72) Inventors: Parakalan Venkataraghavan, Allentown, PA (US); Kannan Rajamani, Basking Ridge, NJ (US); Sanal Cheruvathery, Bangalore (IN); Albert Molina, Alcobendas (ES); Carl Murray, Dublin (IE); Meng-Lin M. Yu, Morganville, NJ (US)

(21) Appl. No.: 14/340,925

(22) Filed: Jul. 25, 2014

(51) Int. Cl. H04L 5/00; H04B 1/69

(52) U.S. Cl. CPC H04L 5/0016; H04B 1/69

(57) ABSTRACT

A configurable transmitter hardware block and corresponding methods for configuring and employing the configurable transmitter hardware block are provided. A configurable transmitter that supports a plurality of channel types comprises a bit selection/manipulation module that performs a bit selection function and/or a bit manipulation function; a modulation mapping module, a gain multiplication module; a spreading/scrambling module that performs a spreading function and/or a scrambling function; and a channel combining module, wherein the configurable transmitter is configured using a plurality of sets of control signals that configure one or more of the modules, wherein each of the sets of control signals are precomputed for a corresponding one of the channel types. An exemplary Generic Channel Processing Iteration routine configures the configurable transmitter based on one set of control signals corresponding to a desired one of the channel types by (a) obtaining the set of control signals corresponding to the desired one of the channel types; and (b) applying the obtained set of control signals to one or more of the modules.

### FIELD OF THE INVENTION

The present invention is related to digital signal processing techniques and, more particularly, to techniques for transmitting information.

### BACKGROUND

In digital communication systems, a chip rate processing transmitter often converts data bits into In-phase and Quadrature (IQ) component samples for transmission over a communication channel. Many communication standards have been developed for a wide array of communication technologies. The transmitter must be designed for the specific communication standard or protocol that is employed on a given communication channel.

Most transmitters, however, perform many of the same or similar steps, although typically with different configurations. During a data bit assembly stage, for example, data bits provided by a higher layer are assembled into the proper format for the communication standard, usually defined by framing structures of the protocol. The protocol frames usually consist of different fields of data bits. During a modulation mapping stage, data bits are divided into smaller groups and mapped into symbols, depending upon the modulation type (e.g., BPSK, QPSK, QAM16 or QAM64). The symbols are either real or complex numbers (IQ format) depending upon the modulation type.

During a gain/phase multiplication stage, the mapped symbols are then multiplied by a real or complex gain, which changes the amplitude and phase of the symbols. In some communication systems, such as a Code Division Multiple Access (CDMA) system, the symbols are then spread (replicated), and multiplied by a spreading code to create “chips” (hence, the term “chip rate processing”). The spread symbols or chips are then multiplied by a complex scrambling code that typically comprises a series of values that are (+/−1 +/−j). In CDMA systems, for example, scrambling codes are used to distinguish multiple users or multiple cells. The symbols are then multiplied by the complex samples of a carrier wave (sin/cos) to create the modulated waveform in either a single or multi carrier system. The modulated waveforms of each user are summed up for transmission over a common antenna

A number of techniques have been proposed or suggested for implementing Wideband CDMA (WCDMA) downlink (transmit) channels; for example, using a combination of a digital signal processor (DSP) and a hardware accelerator. Hardware acceleration is typically also used to handle various bit level operations that are ill-suited for a general purpose DSP. Each channel type, however, has its own peculiarities and asymmetries with respect to the slot format, gains for each field, diversity encoding and is therefore handled as a separate case in the hardware accelerator. Thus, separate hardware is required for each channel type and any errors in implementation are difficult, if not impossible to correct, without updating the silicon design. In addition, the WCDMA standards continue to evolve, with new types of channels being defined as the standards evolve. It is very difficult to handle these new channels with a rigid hardware accelerator, and usually, the silicon design must be updated to accommodate these new channels.

A need therefore exists for implementing transmitters for a plurality of channel types. A further need exists for a configurable transmitter hardware block and methods for configuring and employing the configurable transmitter hardware block.

### SUMMARY

Generally, a configurable transmitter hardware block and corresponding methods for configuring and employing the configurable transmitter hardware block are provided. According to one aspect of the invention, a configurable transmitter that supports a plurality of channel types comprises a bit selection/manipulation module that performs one or more of a bit selection function and a bit manipulation function; a modulation mapping module, a gain multiplication module; a spreading/scrambling module that performs one or more of a spreading function and a scrambling function; and a channel combining module, wherein the configurable transmitter is configured using a plurality of sets of control signals that configure one or more of the modules, wherein each of the sets of control signals are precomputed for a corresponding one of the channel types.

In one exemplary embodiment, the plurality of control signals comprise one or more of a channel configuration parameters signal, a state parameters signal and a block level control pattern. The channel configuration parameters signal comprises one or more of a channel type identifier, modulation type and spread factor. In one exemplary embodiment, the configurable transmitter is invoked by an output of a hardware state machine and/or an instruction in a vector processor. One or more of the control and state parameters signals are stored in a header associated with the instruction.

According to one aspect of the invention, a method for implementing a plurality of channel types comprises (i) providing a configurable transmitter comprising: (a) a bit selection/manipulation module that performs one or more of a bit selection function and bit manipulation function; (b) a modulation mapping module, (c) a gain multiplication module; (d) a spreading/scrambling module that performs one or more of a spreading function and a scrambling function; and (e) a channel combining module, wherein the configurable transmitter is configured using a plurality of sets of control signals that configure one or more of the modules, wherein each of the sets of control signals are precomputed for a corresponding one of the channel types; and (ii) performing a Generic Channel Processing Iteration routine comprising the following steps to configure the configurable transmitter based on one of the sets of control signals corresponding to the desired one of the channel types: (a) obtaining the set of control signals corresponding the desired one of the channel types; and (b) applying the obtained set of control signals to one or more of the modules.

The Generic Channel Processing Iteration routine optionally further comprises the steps of loading one or more of primary data, secondary data and a block level control pattern based on one or more header pointers; computing and accumulating one or more output samples, and storing an updated state for a subsequent iteration.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of a portion of a conventional multi-user/multi-channel digital transmitter;

FIGS. 2A and 2B illustrate exemplary frame structures associated with an exemplary downlink Dedicated Physical Channel (DPCH) and an exemplary Fractional Dedicated Physical Channel (F-DPCH), respectively;

FIGS. 3A and 3B illustrate exemplary Space-Time Block Coding Based Transmit Diversity (STTD) encoding for QPSK and 16QAM modulations, respectively;

FIG. 4 is a block diagram of a configurable transmitter hardware block that incorporates aspects of the present invention for an exemplary transmitter having two antennas;

FIG. 5 illustrates the exemplary bit selection/manipulation stage of FIG. 4 in further detail;

FIG. 6 illustrates an exemplary arrangement of channel headers that store a plurality of control signals that configure the configurable transmitter of FIG. 4;

FIG. 7 illustrates an exemplary transmit frame comprised of processing blocks with block level control patterns for each processing block;

FIG. 8 illustrates exemplary pseudo code for a processing loop that incorporates aspects of the present invention;

FIG. 9 illustrates an exemplary alternate arrangement of channel headers that store a plurality of control signals that configure the configurable transmitter of FIG. 4; and

FIG. 10 illustrates exemplary alternate pseudo code for a processing loop that processes the alternate arrangement of channel headers of FIG. 9.

### DETAILED DESCRIPTION

Aspects of the present invention provide a configurable transmitter hardware block and methods for configuring and employing the configurable transmitter. The configurable transmitter comprises a plurality of configurable modules that are configured using a plurality of sets of control signals. In one exemplary embodiment, the sets of control signals are precomputed for each corresponding channel type. Each desired channel type can be implemented by precomputing a set of control signals for the channel type.

According to one aspect of the invention, the configurable transmitter hardware block implements a generic transmit channel and includes a plurality of modules for implementing the common, unchanging part of chip rate transmit processing. In one exemplary embodiment, the configurable transmitter hardware block comprises a bit selection/manipulation module; a modulation mapping module, a gain multiplication module; a spreading/scrambling module; and a channel combining module. The configurable transmitter is configured using a plurality of sets of control signals that configure one or more of the modules.

According to another aspect of the invention, the configurable transmitter hardware block is integrated as an instruction into a vector processor, and this instruction is called as part of a processing loop that implements the various downlink channels for a particular transmitter. A configurable transmitter software instruction keyword is optionally part of an instruction set of a vector processor. In a further variation, the configurable transmitter hardware block is invoked by an output of a hardware state machine.

Challenges in Chip Rate Processing Implementation

At first glance, it may seem like it should be possible to build a high performance chip rate transmitter using a parallel array of processing hardware since the same set of operations is performed to compute all chips for all channels. There are numerous issues, however, that make this difficult.

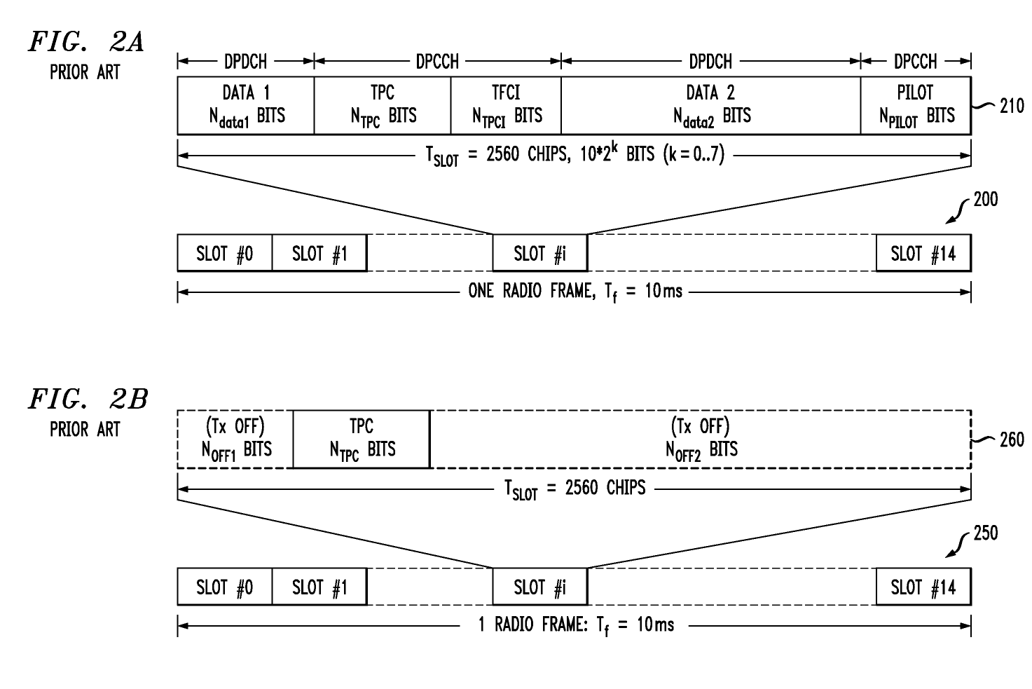

For example, a number of standards (e.g., WCDMA) specify several different channel types, each having its own frame structure and modulation type. There are different fields in a frame, and symbols corresponding to each field must be weighted with the respective gain of that field for each user, as discussed further below in conjunction with FIG. 2.

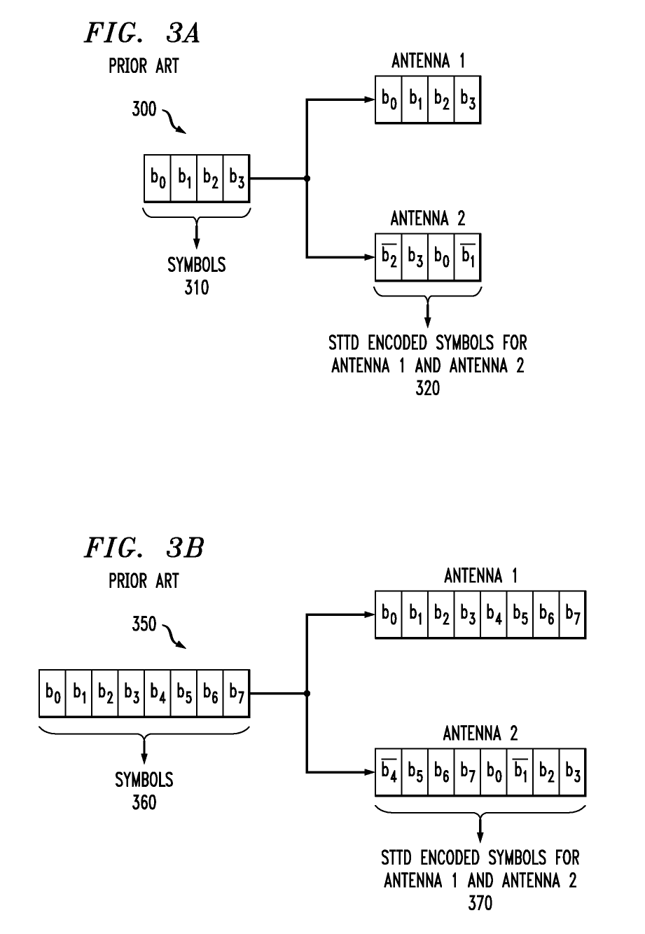

In addition, many transmit channels also have diversity modes (e.g., Space-Time Transmit Diversity (STTD)) that require special bit level processing to create the transmit data frame for the diversity antenna. There are also several exceptions in how this STTD encoding is to be done for certain channels, and for the pilot fields of the transmit frames, which need to be addressed, as discussed further below in conjunction with FIG. 3. An example from the WCDMA standard TS 25.211 is shown below:

The transmit gains for different fields vary with time, and gain changes are periodically provided by a power control feedback loop. There are typically tight requirements regarding when the gain values should be updated in the transmitter.

For some channel types (e.g., Dedicated Physical Channel (DPCH) and an exemplary Fractional Dedicated Physical Channel (F-DPCH), Fractional Transmitted Precoding Indicator Channel (F-TPICH)), feedback loops also provide the values for some bits (e.g., Transmit Power Control (TPC), Transmitted Precoding Indicator (TPI)) to be transmitted in the frame. The remaining transmit data bits are provided by the upper layer. Thus, the data to be assembled for the transmit frame comes from two different sources (upper layer and feedback loop), that are not necessarily synchronized. Thus, the assembly of the transmit frame from these sources must be properly synchronized to the transmit timing. The feedback loop imposes tight latency requirements on the downlink; hence, there is very little time available for the transmitter to assemble the transmit frame with the feedback control bits and incorporate the new gain in transmission. The sheer heterogeneity of the various channel types in the downlink makes it challenging to implement a chip rate processing transmitter and to achieve the high performance needed to support a large number of users/channels.

In addition, depending upon channel type/slot format, various spread factors are used (ranging typically from 4 to 512) while the output chip rate is kept constant. As a result, the rate of consumption of the input data varies correspondingly across different channels. This non-uniformity again makes it difficult to use a simple parallel hardware implementation.

Finally, channels that need to support 2×2 Multiple Input/Multiple Output (MIMO) such as the case in High Speed Downlink Packet Access (HSDPA) needs to be accommodated as well.

As discussed hereinafter, various aspects of the present invention recognize that the sheer heterogeneity of processing present across various channel types, and across the various fields of each channel type make it difficult to improve performance by merely parallelizing the hardware. Latency requirements due to feedback loops add to this difficulty by constraining the size of the maximum block which can be processed.

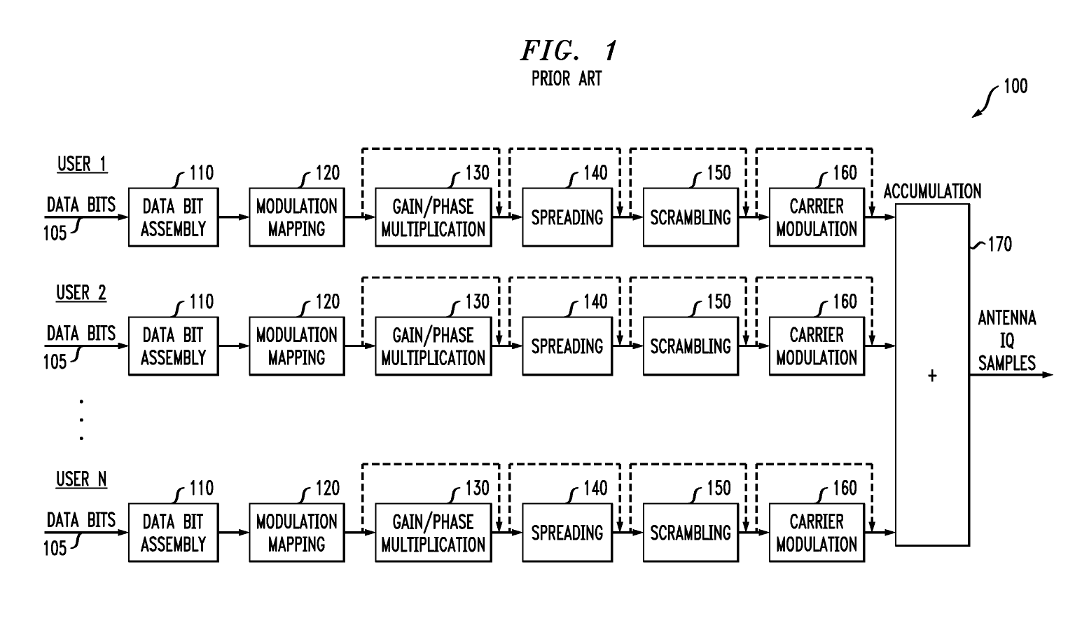

FIG. 1 is a schematic block diagram of a portion of a conventional multi-user/multi-channel digital transmitter 100. As noted above, many conventional transmitters, such as the conventional multi-user/multi-channel digital transmitter 100 of FIG. 1, perform many of the same or similar steps, although typically with different configurations. The exemplary conventional multi-user/multi-channel digital transmitter 100 of FIG. 1 comprises a data bit assembly stage 110, a modulation mapping stage 120, a gain/phase multiplication stage 130, a spreading stage 140, a scrambling stage 150, a carrier modulation stage 160 and a channel combining stage 170.

In the exemplary data bit assembly stage 110, data bits 105 provided by a higher layer are assembled into the proper format for the communication standard, usually defined by framing structures of the protocol. The protocol frames usually consist of different fields of data bits, as discussed further below in conjunction with FIG. 2. During the modulation mapping stage 120, data bits are divided into smaller groups and mapped into symbols, depending upon the modulation type (e.g., BPS K, QPSK, QAM16 or QAM64). The symbols are either real or complex numbers (IQ format) depending upon the modulation type.

During the gain/phase multiplication stage 130, the mapped symbols are then multiplied by a real or complex gain, which changes the amplitude and phase of the symbols. In some communication systems, such as a Code Division Multiple Access (CDMA) system, the symbols are then spread (replicated) at spreading stage 140, and multiplied by a spreading code to create “chips” (hence, the term “chip rate processing”). The spread symbols or chips are then multiplied by a complex scrambling code at scrambling stage 150 that typically comprises a series of values that are (+/−1 +/−j). In CDMA systems, for example, scrambling codes are used to distinguish multiple users or multiple cells.

The symbols are then multiplied by the complex samples of a carrier wave (sin/cos) at carrier modulation stage 160 to create the modulated waveform in either a single or multi carrier system. The modulated waveforms of each user are summed up for transmission over a common antenna (not shown) by channel combining stage 170.

As noted above, one of the challenges of implementing a configurable transmitter hardware block is that symbols corresponding to each field of a frame must be weighted with the respective gain of that field for each user. FIGS. 2A and 2B illustrate exemplary frame structures 200, 250 associated with an exemplary downlink Dedicated Physical Channel (DPCH) and an exemplary Fractional Dedicated Physical Channel (F-DPCH), respectively. See, for example, 3GPP TS 25.211.

As shown in FIGS. 2A and 2B, each exemplary frame structure 200, 250 comprises a plurality of slots and a given exemplary slot i 210, 260 associated with each exemplary frame structure 200, 250, respectively, is shown in greater detail. Each exemplary slot i 210, 260 comprises a plurality of fields, where the symbols of each field must be weighted with the respective gain of that field for each user (as defined by the appropriate standard or protocol for the given transmission channel).

As noted above, many transmit channels have diversity modes (e.g., Space-Time Transmit Diversity) that require special bit level processing to create the transmit data frame for the diversity antenna. FIGS. 3A and 3B illustrate exemplary STTD encoding 300, 350 for QPSK and 16QAM modulations, respectively. See, for example, 3GPP TS 25.211. Generally, the exemplary STTD encoding 300, 350 shuffle and/or invert one or more bits in symbols 310, 360 for each exemplary antenna 1 and 2 to generate STTD encoded symbols 320, 370 for each exemplary antenna 1 and 2.

Configurable Transmitter Hardware Block

As noted above, aspects of the present invention overcome the limitations of conventional approaches and provide improved performance as well as flexibility in implementing chip rate transmission. A configurable transmitter hardware block is provided, as well as methods for configuring and employing the configurable transmitter. The configurable transmitter comprises a plurality of configurable modules that are configured using a plurality of sets of control signals, as discussed further below. The exemplary configurable transmitter hardware block implements a generic transmit channel and includes a plurality of modules for implementing the common, unchanging part of chip rate transmit processing.

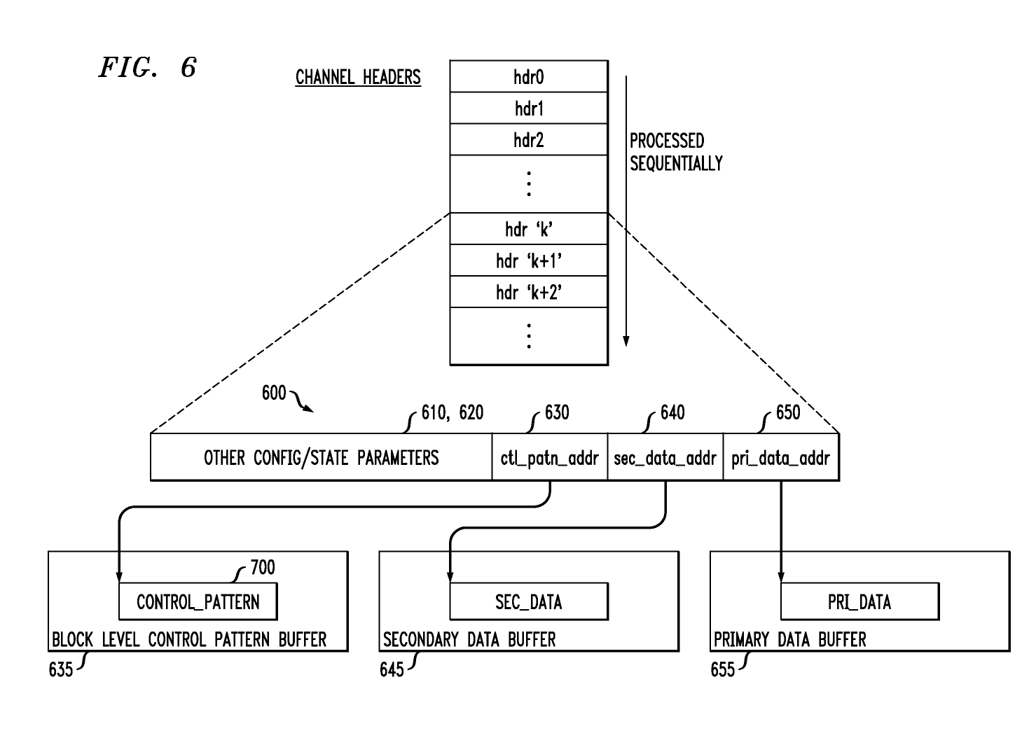

In one exemplary embodiment, a channel header 600, as discussed further below in conjunction with FIG. 6, stores the plurality of control signals that configure the configurable transmitter hardware block. The exemplary control signals comprise a channel configuration parameters signal, a state parameters signal and a block level control pattern. The exemplary channel configuration parameters signal comprises a channel type identifier, modulation type and spread factor. In addition, the exemplary channel header 600 comprises a pointer to a primary data buffer and a pointer to a secondary data buffer.

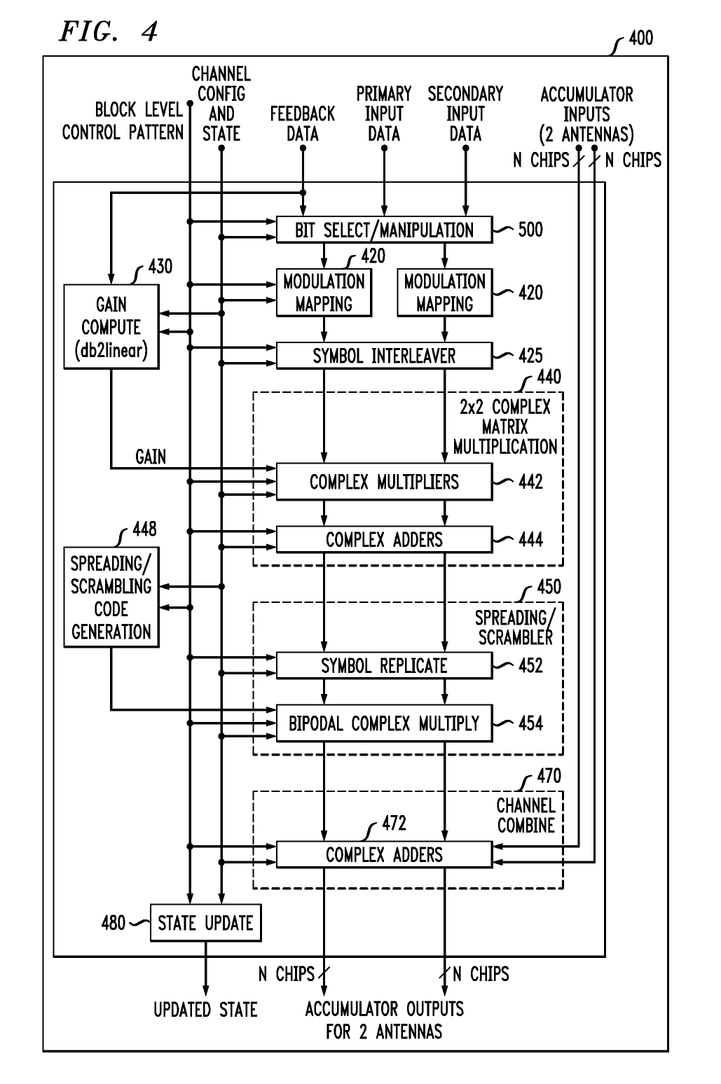

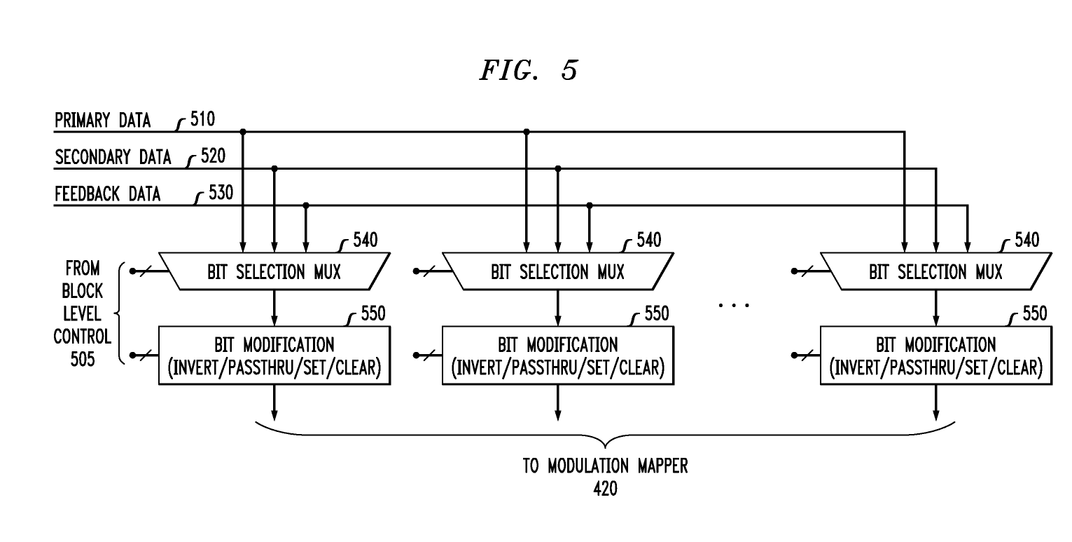

FIG. 4 is a block diagram of a configurable transmitter hardware block 400 that incorporates aspects of the present invention for an exemplary transmitter having two antennas. As shown in FIG. 4, the exemplary configurable transmitter hardware block 400 comprises a bit selection/manipulation stage 500, as discussed further below in conjunction with FIG. 5, a modulation mapping stage 420, a symbol interleaver 425, a gain/phase multiplication stage 440, a spreading/scrambling stage 450 and a channel combining stage 470.

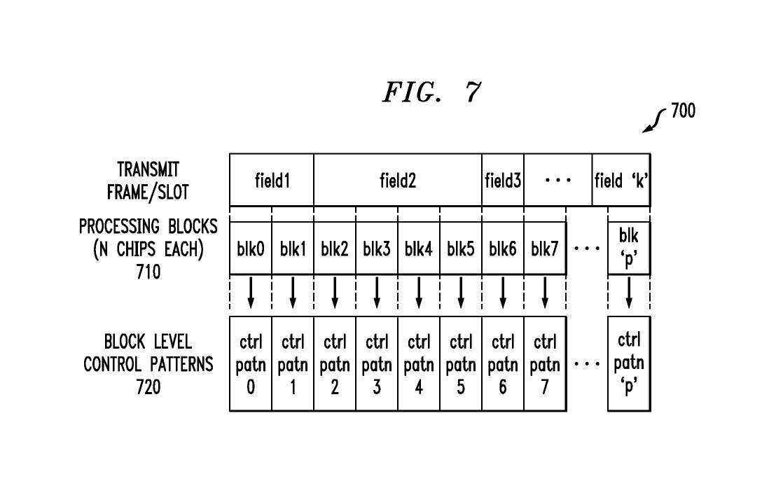

As shown in FIG. 4, the exemplary configurable transmitter hardware block 400 accepts as inputs the Data bits from multiple sources (e.g., Primary and Secondary data sources), channel configuration parameters and state, as discussed further below in conjunction with FIG. 6, a block level control pattern, as discussed further below in conjunction with FIG. 7, and two antenna accumulator inputs (for the exemplary two antenna implementation of FIG. 4). The exemplary configurable transmitter hardware block 400 computes a fixed number “N” chips of output for each antenna and adds these to the two antenna accumulator inputs (to accumulate with chips of other users/channels). The value of “N” is chosen by performing an appropriate tradeoff between cost, latency and performance requirements of the application, thus parallelizing the computational hardware to an optimal extent.

In the exemplary bit selection/manipulation stage 500, data bits comprised of feedback data, primary input data and secondary input data, as discussed further below in conjunction with FIG. 5, are assembled into the proper format for the communication standard, usually defined by framing structures of the protocol. The protocol frames usually consist of different fields of data bits, as discussed above in conjunction with FIG. 2. During the modulation mapping stage 420, data bits are divided into smaller groups and mapped into symbols, depending upon the modulation type (e.g., BPSK, QPSK, QAM16 or QAM64). The symbols are either real or complex numbers (IQ format) depending upon the modulation type. The exemplary modulation mapping stage 420 creates groups of data bits which are output by the Bit Select/Manipulation unit 500 and maps them to (I,Q) symbols of the appropriate constellation for the channel. The mapping/constellation is specified by the channel Configuration input, as discussed further below in conjunction with FIG. 6.

The symbols are then optionally interleaved using symbol interleaver 425. The exemplary symbol interleaver 425 interleaves alternate symbols of the two antennas, if needed, for a particular channel. For example, interleaving is required for MIMO channels in HSDPA. The type of interleaving required is specified by the Configuration and Block Level Control inputs of the channel, as discussed further below.

During the gain/phase multiplication stage 440, the mapped symbols are then multiplied by a real or complex gain using complex multipliers 442, which changes the amplitude and/or phase of the symbols. The gain value is computed by a gain compute module 430, based on the feedback data. The exemplary gain compute module 430 computes the gain to be applied for each field of the transmit slot based on the control/configuration signals. Gains for each field are usually determined by summing two or more component gains, which are expressed in dB, so this module 430 also includes a dB-to-linear conversion. Module 430 uses these linear gains along with phase update information provided by the Channel Control and Feedback inputs and generates the coefficients of one or more 2×2 complex matrices with which the input symbols are multiplied.

The amplitude or phase adjusted symbols are then added by complex adders 444. The complex multipliers 442 and complex adders 444 optionally implement a 2×2 complex matrix multiply operation on the two streams of input symbols. The 2×2 complex matrix multiply operation can be used to apply gain to different fields of a channel, and also implement diversity schemes (e.g., 2×2 MIMO, Closed Loop Transmit Diversity) Higher order MIMOs (4×4) can be implemented by breaking them down into component 2×2 MIMOs.

In some communication systems, such as a Code Division Multiple Access (CDMA) system, the symbols are then spread (replicated) using a symbol replicate module 452 in spreading/scrambling stage 450 and multiplied by a combined spreading/scrambling code generated by a spreading/scrambling code generator 448 using a bipodal complex multiply module 454 to create N “chips” (hence, the term “chip rate processing”). The spreading/scrambling code generated by the spreading/scrambling code generator 448 is based on Channel Configuration and current State. The spreading/scrambling code generator 448 generates spreading and scrambling codes and combines them into a single complex bipodal (+/−1 +/−j) spreading-scrambling code. These chips are produced by spreading of the gain-multiplied symbols and the chips are scrambled by multiplying them with the combined complex bipodal spreading-scrambling code. In CDMA systems, for example, scrambling codes are used to distinguish multiple users or multiple cells.

The N “chips” are combined for transmission using the channel combining stage 470, comprised of complex adders 472 which add the resulting chips to the accumulator inputs, thus combining all users' channels for transmission..

The exemplary configurable transmitter hardware block 400 also updates various state parameters for the channel using state update module 480. Each channel is associated with several parameters, such as pointers to data bits, a pointer to the Block Level Control pattern and counters that form part of the channel state. During each call of the exemplary VEC_GENERIC_CHANNEL instruction, the state update module 480 updates these parameters for the next instruction call.

In further variations, multiplexers may be added at the input stage of each module in the configurable transmitter hardware block 400 to allow primary inputs to be applied. The output of any stage may be tapped and brought out as a primary output. In addition, the functions in FIG. 4 may be divided across several processing units (PUs) which are capable of running in parallel, to enable these operations to be pipelined, and also allow the order of operations to be varied if needed. In further variations, custom functions, such as spreading/scrambling code generation and dB-to-linear conversion can be added into the hardware, and integrated into the processing pipeline.

FIG. 5 illustrates the exemplary bit selection/manipulation stage 500 of FIG. 4 in further detail. As noted above, data bits comprised of primary input data 510, secondary input data 520 and feedback data 530, are assembled at stage 500 into the proper format for the communication standard, usually defined by framing structures of the protocol. The protocol frames usually consist of different fields of data bits, as discussed above in conjunction with FIG. 2

As shown in FIG. 5, the primary input data 510, secondary input data 520 and feedback data 530 are each applied to a plurality of bit selection multiplexers 540, whose selection is controlled by a value from the block level control pattern 505. The data selected by each bit selection multiplexer 540 is then passed to a corresponding bit modification stage 550 where the data is conditionally modified (inverted, set to 1 or 0), based on another value from the block level control pattern 505. For WCDMA downlink, this feature can be used to implement any kind of STTD encoding, and insert pilot bits, while taking into account all the exceptions specified in the standard. The outputs of the bit modification stages 550 are then applied to the modulation mapper 420 of FIG. 4.

As noted above, in one exemplary embodiment, a channel header 600, shown in FIG. 6, stores the plurality of control signals that configure the configurable transmitter 400. The exemplary header 600 is a software data structure stored in memory. The exemplary control signals stored in the header 600 comprise a channel configuration parameters signal 610, a state parameters signal 620 and pointer 630 to a buffer 635 storing a block level control pattern, as discussed further below in conjunction with FIG. 7. The exemplary channel configuration parameters signal 610 comprises a channel type identifier, modulation type and spread factor. In addition, the exemplary channel header 600 comprises a pointer 650 to a primary data buffer 655 and a pointer 640 to a secondary data buffer 645.

FIG. 7 illustrates an exemplary transmit frame 700 comprised of processing blocks 710 (N chips each) with block level control patterns 720 for each processing block. For a set of given inputs, the configurable transmitter 400 computes a fixed number ‘N’ output chips, where ‘N’ is a power of 2. Any transmit frame 700 is broken down into several Processing Blocks 710 of ‘N’ chips each. A set of appropriate control signals corresponding to each block is provided along with the data inputs.

For each processing block of any given channel type, it is possible to determine a priori as to which data bits should be selected, how they should be modified, which gains should be applied, whether transmission should be disabled (DTX), etc. In addition, the block level control pattern is used to select the gain applicable for each block. Based on this, the required Block Level Control signals can be precomputed and stored as a set of precomputed control patterns in memory. At the time of processing a particular block, the appropriate control pattern 720 for that channel type and block number 710 is fetched and provided as input to the configurable transmitter 400. The control pattern 720 for each channel repeats itself periodically. The state of a channel includes a pointer to the current block's Control Pattern to be fetched, as well as the Current Block Count. The Start Address and Period of the Control Pattern buffer and the size of each block's control pattern are specified as part of the static Channel Configuration. The state update block 480 of the configurable transmitter 400 uses these to update the pointer to the channel's current Block Level Control pattern 720 each time.

The different channel types are implemented by precomputing Block Level Control Patterns 720 for each channel type and storing all of these in memory as a library. Each individual channel's Configuration header 600 points to the appropriate pattern 720 to be used, depending upon the channel type.

If a new type of channel is defined in a future version of the standard, the new channel type can be implemented by using a new Block Level Control pattern 720 for this channel, which can be precomputed and stored in memory.

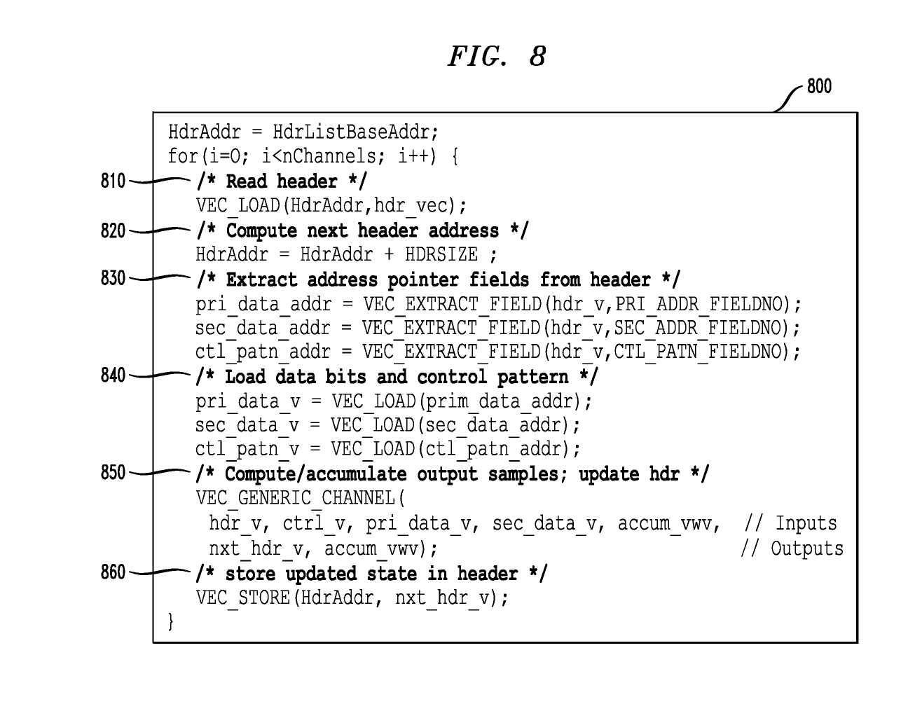

FIG. 8 illustrates exemplary pseudo code 800 for a processing loop that incorporates aspects of the present invention. As shown in FIG. 8, a header address is initialized prior to the loop. The corresponding header is obtained and the next header address is determined during steps 810 and 820. The address pointer fields 630, 640, 650 are then extracted from the header 600 during step 830. The corresponding control pattern and data bits are then loaded from the buffers 635, 645, 655 identified by the pointers 630, 640, 650 during step 840.

The output samples are computed and accumulated during step 850 and the state values are updated. The update state is then stored in the header during step 860.

Further aspects of the invention provide flexible buffering and address pointer management, and the use of different size headers which are all multiples of a common base size to allow for efficient memory use. Memory resources can be allocated as and when users are added, and freed up as and when users are deleted, using simple memory management techniques, without any need for defragmentation/packing.

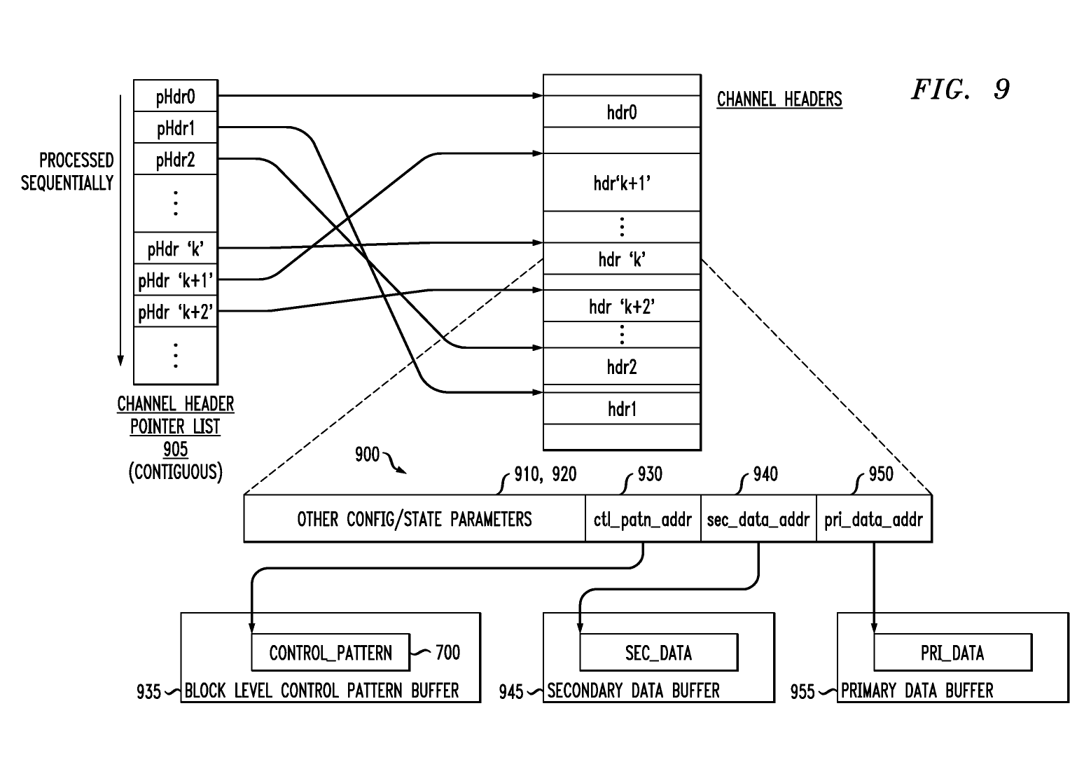

Thus, in one exemplary embodiment, an alternate channel header 900, shown in FIG. 9, stores the plurality of control signals that configure the configurable transmitter 400. The exemplary header 900 is a software data structure stored in memory, in a similar manner to the headers 600 of FIG. 6. A level of indirection is added using pointers in a sequential header pointer list 905. Each pointer points to a corresponding header 900. The exemplary channel headers 900 of FIG. 9 can have different sizes, and also be stored non-contiguously in memory. The contiguous channel header pointer list 905 is processed sequentially and is used to point to a corresponding channel header 900. The pointers in the list 905 are typically small, and occupy a fixed size (e.g., 4 bytes), while the headers 900 are larger e.g., typically 16, 32, 48 or 64 bytes, depending upon the channel type—to optimize memory use).

The exemplary control signals stored in the header 900 comprise a channel configuration parameters signal 910, a state parameters signal 920 and pointer 930 to a buffer 935 storing a block level control pattern, as discussed further below in conjunction with FIG. 7. The exemplary channel configuration parameters signal 910 comprises a channel type identifier, modulation type and spread factor. In addition, the exemplary channel header 900 comprises a pointer 950 to a primary data buffer 955 and a pointer 940 to a secondary data buffer 945.

In a further variation, the channel headers 900 can be implemented as a linked list, where each entry contains a pointer to the next element, as would be apparent to a person of ordinary skill in the art.

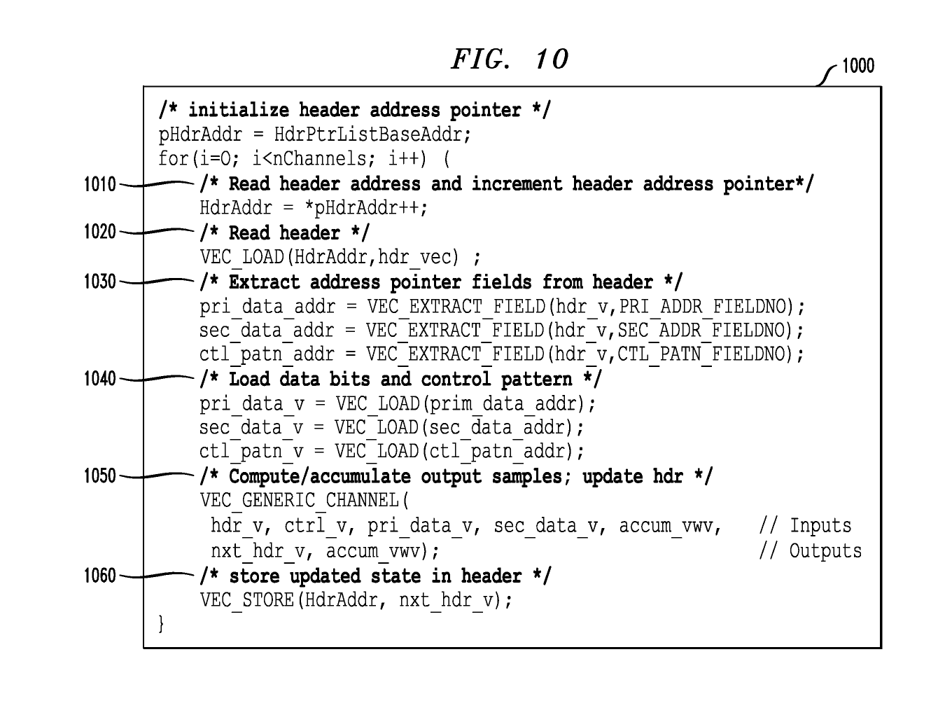

FIG. 10 illustrates exemplary alternate pseudo code 1000 for a processing loop that processes the alternate arrangement of channel headers 900 of FIG. 9. As shown in FIG. 10, a header address pointer is initialized prior to the loop. The header address is read, the header address pointer is incremented and the header is read during steps 1010 and 1020. The address pointer fields 930, 940, 950 are then extracted from the header 900 during step 1030. The corresponding control pattern and data bits are then loaded from the buffers 935, 945, 955 identified by the pointers 930, 940, 950 during step 1040.

The output samples are computed and accumulated during step 1050 and the state values are updated. The updated state is then stored in the header during step 1060.

While the present invention is illustrated herein primarily in the context of chip rate transmit processing, the present invention can be extended to handle transmit processing for other digital communication systems, as would be apparent to a person of ordinary skill in the art. For example, the present invention may be employed in single carrier systems, where the complex matrix multiplication operation of the configurable transmitter 400 can be used to implement modulation by a carrier wave by providing the carrier waveform as a series of complex samples representing cos(2*pi*fc*t) j*sin(2*pi*fc*t), where fc is the carrier frequency. In addition, for multicarrier systems, the multicarrier modulation can be implemented in the time domain, instead of using an IFFT-based approach, by performing carrier modulation as described above and combining all the modulated carriers. Depending on the processing block size used, it may result in better transmit latency than an IFFT based implementation, which requires a minimum block size.

Among other benefits, aspects of the present invention allow transmitters of various communication protocols to be achieved in software, which also allows field updates for adding new features and addressing standard changes. In addition, implementation of most common baseband processing functions in hardware in accordance with the present invention provides high performance. Integrated state update in the hardware significantly speeds up database management functions which would otherwise need to be implemented as a separate control function. The disclosed configurable transmitter 400 can also be used in systems with a latency critical feedback loop, where transmit data and other transmit parameters like gain arrive with low latency. These can be provided either as a data source or as config parameters and used as inputs on a per-channel basis.

### CONCLUSION

While exemplary embodiments of the present invention have been described with respect to digital logic blocks and memory tables within a digital processor, as would be apparent to one skilled in the art, various functions may be implemented in the digital domain as processing steps in a software program, in hardware by circuit elements or state machines, or in combination of both software and hardware. Such software may be employed in, for example, a digital signal processor, application specific integrated circuit or micro-controller. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, wherein, when the program code is loaded into and executed by a machine, such as a processor, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital processor, a microprocessor, and a micro-controller.

It is to be understood that the embodiments and variations shown and described herein are merely illustrative of the principles of this invention and that various modifications may be implemented by those skilled in the art without departing from the scope and spirit of the invention.

What is claimed:

1. A configurable transmitter that supports a plurality of channel types, comprising:
a bit selection/manipulation module that performs one or more of a bit selection function and a bit manipulation function;
a modulation mapping module, a gain multiplication module;
a spreading/scrambling module that performs one or more of a spreading function and a scrambling function; and
a channel combining module, wherein said configurable transmitter is configured using a plurality of sets of control signals that configure one or more of said modules, wherein each of said sets of control signals are precomputed for a corresponding one of said channel types.

2. The configurable transmitter of claim 1, wherein said plurality of control signals comprise one or more of a channel configuration parameters signal, a state parameters signal and a block level control pattern, and wherein said channel configuration parameters signal comprises one or more of a channel type identifier, modulation type and spread factor.

3. The configurable transmitter of claim 1, wherein said configurable transmitter computes a fixed number “N” chips of output for each antenna and adds said “N” chips of output to antenna accumulator inputs.

4. The configurable transmitter of claim 2, wherein said configurable transmitter computes updates to said state parameters signal for a given channel.

5. The configurable transmitter of claim 2, wherein said bit selection/manipulation module comprises an array of multiplexers controlled by said block level control pattern, wherein each of said multiplexers can independently select a bit from a plurality of sets of data input bits and wherein outputs of each of said multiplexers can be conditionally modified based on said block level control pattern.

6. The configurable transmitter of claim 1, wherein said modulation mapping module creates groups of data bits and maps said groups of data bits to (I, Q) symbols of an appropriate constellation for a desired one of said channel types based on a channel configuration input.

7. The configurable transmitter of claim 1, further comprising a gain computation module that computes a gain to be applied by said gain multiplication module to each field of a transmit slot based on one or more control and configuration signals for a desired one of said channel types and wherein a gain used for a particular field is selected using a block level control pattern.

8. The configurable transmitter of claim 1, wherein said spreading/scrambling module generates one or more of spreading and scrambling codes based on one or more control and configuration signals for a desired one of said channel types.

9. The configurable transmitter of claim 1, wherein said gain multiplication module comprises one or more of complex multipliers and complex adders to implement a complex matrix multiply operation on a plurality of streams of input symbols.

10. The configurable transmitter of claim 1, wherein said configurable transmitter is invoked by one or more of an output of a hardware state machine and an instruction in a vector processor.

11. The configurable transmitter of claim 10, wherein one or more of said control and state parameters signals are stored in a header associated with said instruction.

12. The configurable transmitter of claim 1, wherein said configurable transmitter further comprises one or more of a symbol interleaver to interleave symbols for a plurality of antennas and means for obtaining transmit data from a plurality of sources.

13. A method for implementing a plurality of channel types, said method comprising:
providing a configurable transmitter comprising:
a bit selection/manipulation module that performs one or more of a bit selection function and a bit manipulation function;
a modulation mapping module,
a gain multiplication module;
a spreading/scrambling module that performs one or more of a spreading function and a scrambling function; and
a channel combining module, wherein said configurable transmitter is configured using a plurality of sets of control signals that configure one or more of said modules, wherein each of said sets of control signals are precomputed for a corresponding one of said channel types; and
performing a Generic Channel Processing Iteration routine comprising the following steps to configure said configurable transmitter based on one of said sets of control signals corresponding to said desired one of said channel types:
obtaining said set of control signals corresponding to said desired one of said channel types; and
applying said obtained set of control signals to one or more of said modules.

14. The method of claim 13, wherein said Generic Channel Processing Iteration routine further comprises the steps of computing and accumulating one or more output samples, and storing an updated state for a subsequent iteration.

15. The method of claim 13, wherein said Generic Channel Processing Iteration routine further comprises the steps of loading one or more of primary data, secondary data and a block level control pattern based on one or more header pointers.

16. The method of claim 13, wherein said plurality of control signals comprise one or more of a channel configuration parameters signal comprising one or more of a channel type identifier, modulation type and spread factor; a state parameters signal and a block level control pattern.

17. The method of claim 13, wherein said modulation mapping module creates groups of data bits and maps said groups of data bits to (I, Q) symbols of an appropriate constellation for a desired one of said channel types based on a channel configuration input.

18. The method of claim 13, wherein said spreading/scrambling module generates one or more of spreading and scrambling codes based on one or more control and configuration signals for a desired one of said channel types.

19. The method of claim 13, wherein said gain multiplication module comprises one or more of complex multipliers and complex adders to implement a complex matrix multiply operation on a plurality of streams of input symbols.

20. The method of claim 13, wherein said configurable transmitter is invoked by one or more of an output of a hardware state machine and an instruction in one or more of a vector processor, wherein one or more of said control and state parameters signals are stored in a header associated with said instruction.

21. An apparatus that implements a plurality of channel types, comprising:
a configurable transmitter comprising:
a bit selection/manipulation module that performs one or more of a bit selection function and a bit manipulation function;
a modulation mapping module,
a gain multiplication module;
a spreading/scrambling module that performs one or more of a spreading function and a scrambling function; and
a channel combining module, wherein said configurable transmitter is configured using a plurality of sets of control signals that configure one or more of said modules, wherein each of said sets of control signals are precomputed for a corresponding one of said channel types; and
performing a Generic Channel Processing Iteration routine comprising the following steps to configure said configurable transmitter based on one of said sets of control signals corresponding to said desired one of said channel types:
obtaining said set of control signals corresponding to said desired one of said channel types; and
applying said obtained set of control signals to one or more of said modules.

22. The apparatus of claim 21, wherein said Generic Channel Processing Iteration routine further comprises the steps of computing and accumulating one or more output samples, and storing an updated state for a subsequent iteration.
